(19) United States
(12) Patent Application Publication
(10) Pub. No.: US 2004/0264727 A1
(43) Pub. Date: Dec. 30, 2004

(54) Bass reflex-type headphone

(76) Inventor: Sung-Il Kim, Bundang-gu (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/487,623

(22) PCT Filed: Aug. 24, 2002
(86) PCT No.: PCT/KR02/10601

(30) Foreign Application Priority Data
Aug. 24, 2001 (KR) 2001/51401

(51) Int. Cl. H04R 25/00

(52) U.S. Cl. 381/370; 381/374

(57) ABSTRACT

Bass-reflective headphones providing improved frequency characteristics and sound quality by enforcing bass using reflected sounds are provided. The bass-reflective headphones to be hold over the head or ears of a listener includes for each ear piece a speaker unit to be positioned toward the listener's ear to emanate direct sounds towards the listener's ear, an enclosure enclosing the rear of the speaker unit, and a reflector unit to reflect phase-inverted sounds generated at the rear of the speaker unit in order to enforce bass using the reflected sounds. The bass-reflective headphones enhance a low-frequency sound component, which cannot be effectively reproduced with the small speaker units of general headphones, to provide high sound quality and reduce distortion of reproduction sounds. Therefore, a listener can experience bass-enriched sounds and spatial and realistic effects with great interest when listening to music or watching a movie with the bass-reflective headphones.

### BACKGROUND OF THE INVENTION

1. Field of the Invention

The present invention relates to bass-reflective headphones, and more particularly, to bass-reflective headphones providing improved frequency characteristics and sound quality by enforcing bass using reflected sounds.

2. Description of the Related Art

Headphones are used by being hold over a listener's head or ears to enjoy music or movies without disturbing any potential neighbor. Small speaker units enclosed in headphones are positioned as close as possible to the listener's ears in order to direct sounds emanating from the speaker units toward the eardrums. As the quality of headphones is improved, the use of headphones has become frequent for individuals who wish to enjoy music or movies with enriched and clear sounds without disturbing any neighbors.

Conventional headphones consist of speaker units emanating direct sounds toward the listener's eardrums and enclosures surrounding the rear of the speaker units. Therefore, the listener can perceive only the direct sounds produced in front of the speaker units, and phase-inverted sounds generated at the rear of the speaker units cannot be effectively utilized.

The speaker units of headphones are too small and compact to reproduce sounds having good frequency characteristics as compared with general large speakers. However, the biggest disadvantage of such a small speaker unit is poor reproduction of low frequency components. The conventional headphones cannot effectively reproduce most of the bass that is a main source of sound wave energy and is crucial to sound quality. Therefore, bass distortion is perceived when listening to music with the conventional headphones. Also, when using the conventional headphones, shooting or explosion sounds from a movie, which are sorts of low frequency sounds providing realistic and spatial effects, cannot be transmitted to the viewer, so he/she loses interest in viewing the movie.

In addition, the conventional headphones cannot effectively tune up direct sounds of very different frequencies or a weak frequency component interfering with a crossover frequency in order to provide quality enriched sounds.

### SUMMARY OF THE INVENTION

Accordingly, the present invention provides bass-reflective headphones capable of reproducing high quality sounds by enforcing bass, which cannot be effectively reproduced through small headphone speakers, so that a listener can experience bass-enriched sounds with less distortion when listening to music with the bass-reflective headphones. In addition, when a viewer watches a movie with the bass-reflective headphones according to the present invention, he/she can perceive improved realistic and spatial effects with great interest.

The present invention also provides bass-reflective headphones capable of tuning up direct sounds emanating in front of speaker units, which may exhibit poor reproduction characteristics for a particular frequency range, and indirect reflected sounds in order to reproduce high quality enriched sounds at low costs.

According to an aspect of the present invention, there is provided bass-reflective headphones to be hold over the head or ears of a listener, the bass-reflective headphones comprising for each ear piece: a speaker unit to be positioned toward the listener's ear to emanate direct sounds towards the listener's ear; an enclosure enclosing the rear of the speaker unit; and a reflector unit to reflect phase-inverted sounds generated at the rear of the speaker unit in order to enforce bass using the reflected sounds.

The reflector unit may be at least one cylindrical duct having a front opening facing the listener's ear and a rear opening interconnected with the enclosure, and the inner diameter and length of the cylindrical duct are optimized according to the bass frequency to be enhanced. Alternatively, the reflector unit may be a waveguide connecting a rear space of the enclosure to an opening formed in a front panel of the enclosure.

Alternatively, the speaker unit for each ear piece may comprise a pair of front and rear speaker units to be positioned in the front and rear of the listener's earflap in order to provide front and rear spatial effects, the pair of front and rear speaker units being enclosed by a pair of front and rear enclosures, respectively, and then being enclosed together in a housing with the possibility of being detached the possibility of being detached therefrom. The reflector unit for each ear piece may comprise a pair of front and rear reflection ducts to be positioned in the front and rear of the listener's earflap in order to provide front and rear spatial effects.

The bass-reflective headphones according to the present invention may have a sound conditioning structure capable of conditioning the direct sounds generated from the speaker unit and the indirect sounds reflected by the reflector unit in order to tune up the same. In this case, the sound conditioning structure may comprise: a double separator plate having an opening at one side and two plates facing each other at a predetermined distance to repeatedly reflect the direct sounds and the indirect sounds in zigzag; and a swing plate vertically dividing the opening of the double separator plate.

### BRIEF DESCRIPTION OF THE DRAWINGS

The above and other features and advantages of the present invention will become more apparent by describing in detail exemplary embodiments thereof with reference to the attached drawings in which:

FIG. 1 shows bass-reflective headphones according to an embodiment of the present invention;

FIG. 2 shows bass-reflective headphones according to another embodiment of the present invention;

FIG. 3 shows bass-reflective headphones according to still another embodiment of the present invention;

FIG. 4 is an exploded perspective view of bass-reflective headphones according to yet another embodiment of the present invention, including separate front and rear enclosures, as shown in FIG. 3; and

FIG. 5 is a sectional view of a front enclosure shown in FIG. 4.

### DETAILED DESCRIPTION OF THE INVENTION

Embodiments of base-reflective headphones according to the present invention will be described in detail with reference to the appended drawings.

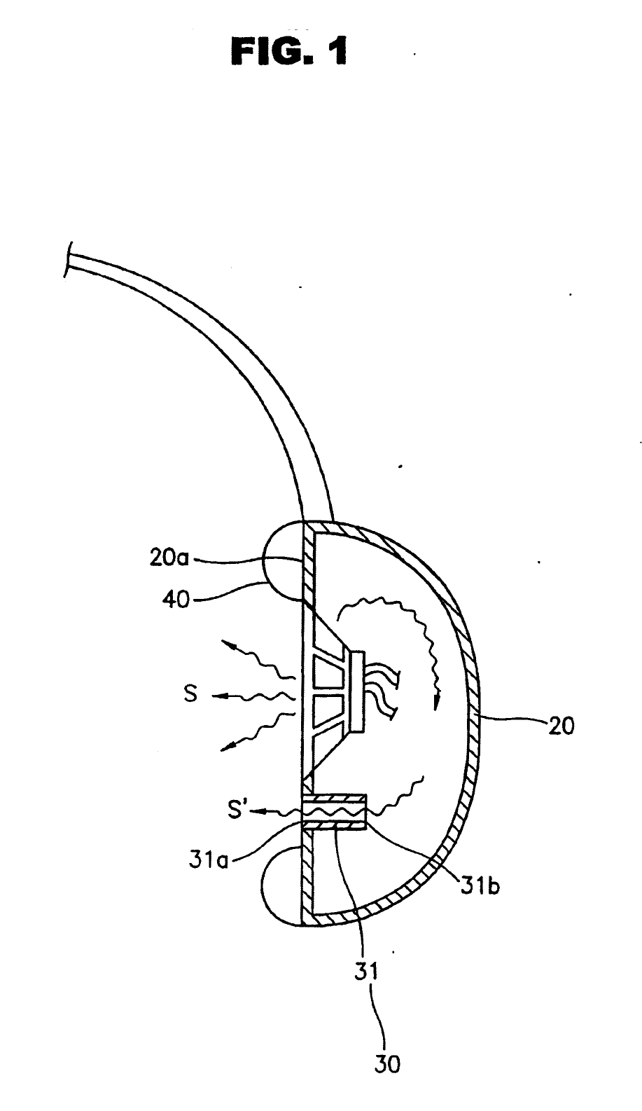

Referring to FIG. 1, bass-reflective headphones according to an embodiment of the present invention, which are worn over a listener's head or ears, include for each ear piece a speaker unit 10, an enclosure, and a reflector unit 30.

The speaker unit 10, a compact part having a very small diameter to reduce its volume and weight, can be installed in any kind of a support member to be brought into contact with the listener's head or ears, for example, in a single or both ends of an arc-shaped headband to be engaged over the listener's head, in a support member shaped to fit behind the listener's ears, or in an ear-plug type support member, which is generally called “ear phones”. The speaker unit 10, having a diaphragm whose entire surface faces the listener's ear, converts electrical energy into sound wave energy to emanate direct sounds (S) toward the listener's ear.

The enclosure 20, which encloses the rear of the diaphragm of the speaker unit 10, prevents phase-inverted sounds generated at the rear of the diaphragm from affecting direct sounds S generated through the front of the diaphragm so as not to degrade the sound quality.

The reflector unit 30 reflects the phase-inverted sounds generated near the rear of the speaker unit 10 and enhances low-frequency bass using the reflected sounds S′. At this time, the reflector unit 30 reflects only phase-inverted sounds of a particular frequency, not the entire phase-inverted sounds.

As an example, referring to FIG. 1, the reflector unit 30 includes at least one cylindrical duct 31 having a front opening 31a facing the sides of a listener's face and a rear opening 31b interconnected with the enclosure 20. The inner diameter and length of the cylindrical duct 31 are optimized according to the frequency of the bass to be enhanced.

The inner wall of the enclosure 20 may be rounded to be concave to make the reflection of the phase-inverted sounds easier and smoother. Although not illustrated in FIG. 1, a reflection and absorption structure that helps the reflection of particular frequencies and the absorption of other frequencies excluding the particular frequencies may be installed within the enclosure 20.

As the diaphragm of the speaker unit 10 slightly vibrates back and forth, the direct sounds S generated at the front of the speaker unit 10 is directly transmitted to the listener's ear, whereas the phase-inverted sounds generated at the rear of the speaker unit 10 is reflected within the enclosure 20. In particular, due to the nature of sound waves, phase-inverted sounds of a particular frequency in accordance with the inner diameter, length, and position of the duct 31 is selected, guided into the front opening 13a through the rear opening 31a of the duct 31, and transmitted into the listener's ear as the reflected sounds S′.

Due to the reflector unit 20, low-frequency bass can be reproduced with the small speaker unit 10. When listening to a music with the bass-reflective headphones according to the present invention, the sound quality of organs, cellos, large drums, and the like, which produce bass sounds, is enhanced. When seeing a movie with the bass-reflective headphones according to the present invention, low-frequency components, such as shooting or explosion sounds, which contribute to realistic and spatial effects, can be effectively reproduced, giving much entertainment to the viewer.

In addition, when the frequency characteristics of the direct sounds S generated at the front of the speaker unit 10 are poor, the direct sounds S can be tuned up by enhancing its problematic frequency component using the reflected sounds S′. Therefore, the quality of the direct sounds S can be greatly improved.

For a soft contact of the enclosure 20 to the sides of the listener's face or ears and for preventing the direct sounds S and the reflected (or indirect) sounds S′ from leaking out of the listener's earflap, it is preferable that a front panel (baffle) 20a of the enclosure 20 be covered with an annular cushion member 40 to surround the speaker unit 10 and the front opening 31a of the duct 31, so that the listener's ear is fully enclosed within the cushion member 40 when the listener wears the headphones.

The cushion member 40 may be formed of any smooth buffering material, such as sponge, foam, or elastic leather or textile, etc.

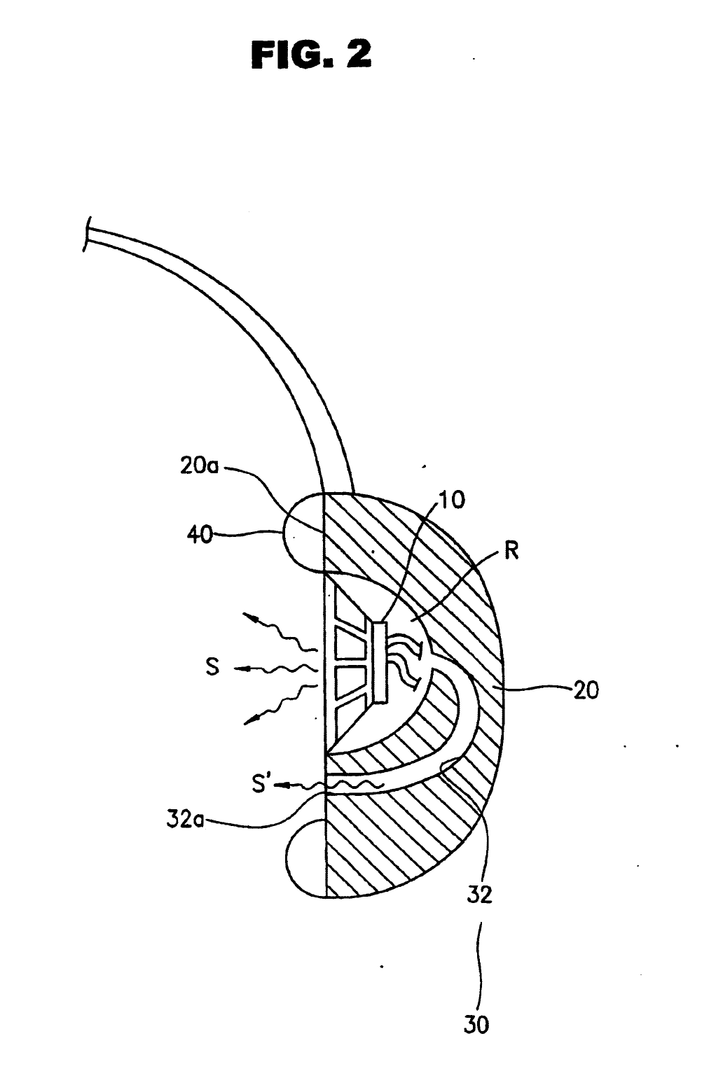

In bass-reflective headphones according to another embodiment of the present invention, as shown in FIG. 2, the reflector unit 30 is formed as a waveguide 32 connecting a rear space R of the enclosure 20 to an opening 32a formed in a front panel of the enclosure 20. The waveguide 32 may be designed to have an optimal inner diameter and length according to a low-frequency component that needs to be enhanced.

Although not illustrated in FIG. 2, a reflection and absorption structure that helps the reflection of particular frequencies and the absorption of other frequencies excluding the particular frequencies may be installed within the waveguide 32.

As the diaphragm of the speaker unit 10 slightly vibrates back and forth, the direct sounds S generated at the front of the speaker unit 10 is directly transmitted to the listener's ear. Due to the nature of sound waves, phase-inverted sounds of a particular frequency in accordance with the inner diameter and length of the waveguide 32 is selected from the phase-inverted sounds generated at the rear of the speaker unit 10 and guided through the waveguide 32 into the listener's ear as the reflected sounds S′.

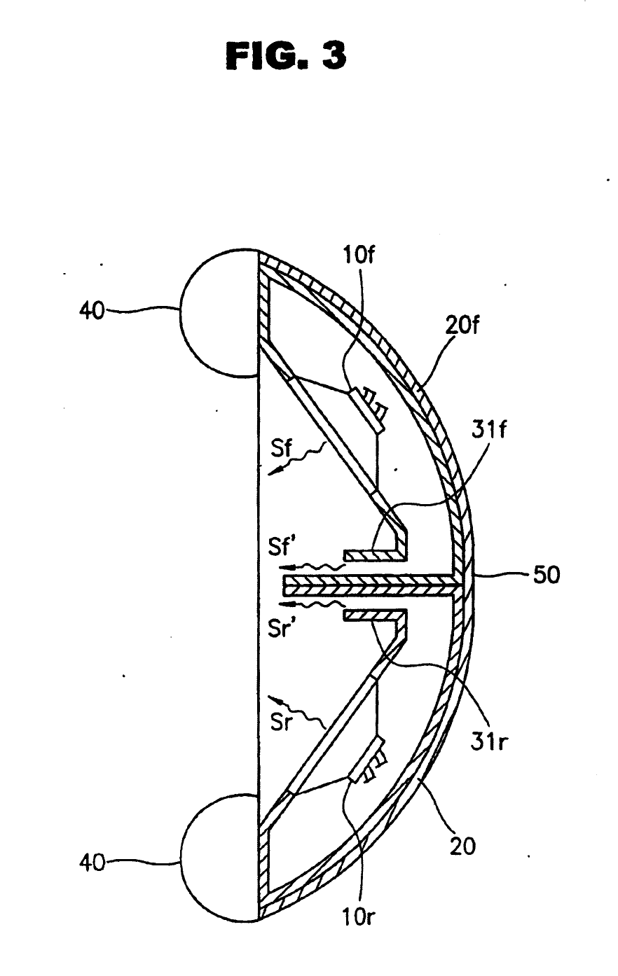

Bass-reflective headphones according to still another embodiment of the present invention are shown in FIG. 3. Referring to FIG. 3, the speaker unit 10 includes a pair of front and rear speaker units 10f and 10r, which will be positioned in the front and rear of the listener's earflap, in order to provide front and rear spatial effects. The front and rear speaker units 10f and 10r are enclosed by front and rear enclosures 20f and 20r, respectively, and then enclosed together in a housing 50 for each ear piece with the possibility of being detached therefrom. The reflector unit 30 includes a pair of front and rear reflection ducts 31f and 31r, which will be positioned in the front and rear of the listener's earflap, for each ear piece in order to provide front and rear spatial effects.

When the listener wears the bass-reflective headphones illustrated in FIG. 3, he/she can enjoy 4-channel 3-dimensional sounds through the four speaker units, the front and rear speaker units 10f and 10r of the left and right ear pieces. In addition, the front and rear reflection ducts 31f and 31r of the left and right ear pieces enhance a low-frequency component, which cannot be effectively reproduced using conventional headphones, through the four speaker units, similar to the effects provided by a woofer.

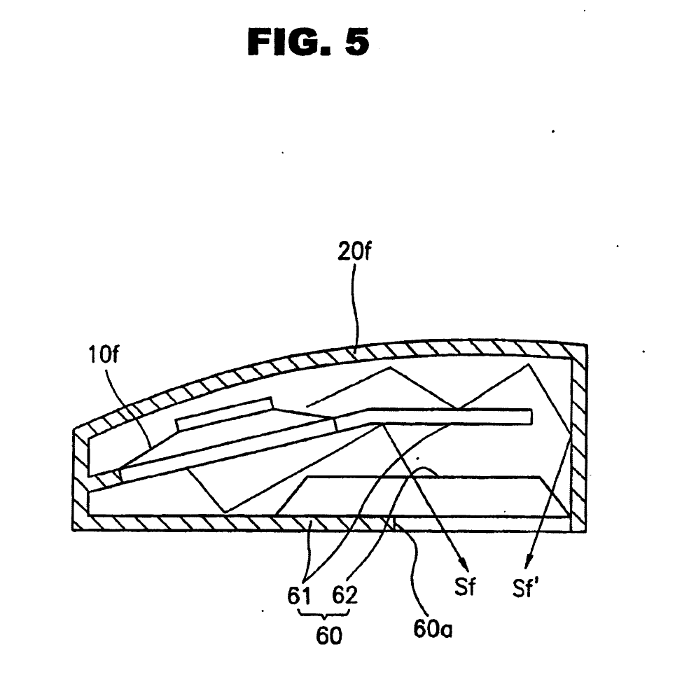

Alternatively, as shown in FIG. 5, bass-reflective headphones according to yet another embodiment of the present invention may be manufactured to have a sound conditioning structure 60 capable of conditioning the direct sounds Sf from the front speaker unit 10f and the indirect sounds S′f reflected by a reflector unit to tune up the same.

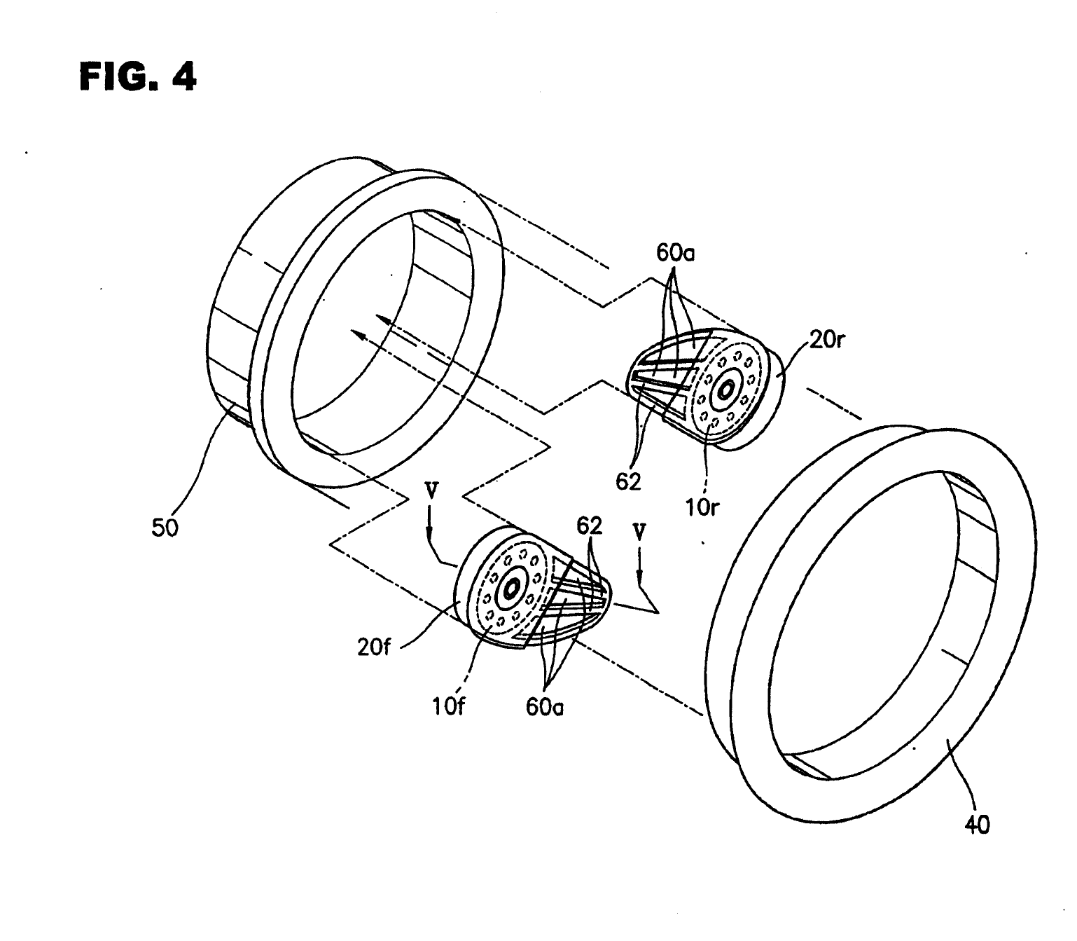

In particular, referring to FIGS. 4 and 5, the sound conditioning structure 60 includes a double separator plate 61 and a wing plate 62. The double separator plate 61 has an opening 60a at one side and two plates facing each other at a predetermined distance to repeatedly reflect the direct sounds Sf and the indirect sounds S′f in zigzag. The swing plate 62 vertically divides the opening 60a of the double separator plate 61.

Therefore, the indirect sounds S′f as well as the direct sounds Sf are reflected further by the sound conditioning structure 60, rather than be provided directly to the listener's ear, to have their frequency characteristics improved and tuned up to provide good sound field characteristics and sound quality.

Although the above embodiments have been described only with reference to headphones, the present invention can be applied to any kind of an acoustic device used in contact with the ears, such as earphones, backphones, or hearing aids.

While this invention has been particularly shown and described with reference to exemplary embodiments thereof, it will be understood by those skilled in the art that various changes in form and details may be made therein without departing from the spirit and scope of the invention as defined by the appended claims.

As described above, bass-reflective headphones according to the present invention enhance a low-frequency sound component, which cannot be effectively reproduced with the small speaker units of conventional headphones, to provide high sound quality and reduce distortion of reproduction sounds. Therefore, a listener can experience bass-enriched sounds and spatial and realistic effects with great interest when listening to music or watching a movie with the bass-reflective headphones according to the present invention. When a particular frequency of sounds emanating from the front of the speaker units has poor reproduction characteristics, the particular frequency can be tuned up and can be properly heard by enriching indirect sounds. A high quality sound reproduction can be realized with the bass-reflective headphones according to the present invention at low costs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. Bass-reflective headphones to be hold over the head or ears of a listener, the bass-reflective headphones comprising for each ear piece:
a speaker unit to be positioned toward the listener's ear to emanate direct sounds towards the listener's ear;
an enclosure enclosing the rear of the speaker unit; and
a reflector unit to reflect phase-inverted sounds generated at the rear of the speaker unit in order to enforce bass using the reflected sounds.

2. The bass-reflective headphones of claim 1, wherein the enclosure has a concave inner wall to make the reflection of the phase-inverted sounds easier and smoother.

3. The bass-reflective headphones of claim 1, wherein the reflector unit is at least one cylindrical duct having a front opening facing the listener's ear and a rear opening interconnected with the enclosure, and the inner diameter and length of the cylindrical duct are optimized according to the bass frequency to be enhanced.

4. The bass-reflective headphones of claim 1, wherein the reflector unit is a waveguide connecting a rear space of the enclosure to an opening formed in a front panel of the enclosure.

5. The bass-reflective headphones of claim 1, further comprising a cushion member over a front panel of the enclosure to surround the speaker unit and the reflector unit and to enclose the listener's ear in order to provide a soft contact of the enclosure to the listener's ear and in order to prevent the direct and indirect sounds from leaking out of the listener's earflap.

6. The bass-reflective headphones of claim 1, wherein the speaker unit for each ear piece comprises a pair of front and rear speaker units to be positioned in the front and rear of the listener's earflap in order to provide front and rear spatial effects, the pair of front and rear speaker units being enclosed by a pair of front and rear enclosures, respectively, and then being enclosed together in a housing with the possibility of being detached the possibility of being detached therefrom, and
the reflector unit for each ear piece comprises a pair of front and rear reflection ducts to be positioned in the front and rear of the listener's earflap in order to provide front and rear spatial effects.

7. The bass-reflective headphones of claim 6, having a sound conditioning structure capable of conditioning the direct sounds generated from the speaker unit and the indirect sounds reflected by the reflector unit in order to tune up the same.

8. The bass-reflective headphones of claim 7, wherein the sound conditioning structure comprises:
a double separator plate having an opening at one side and two plates facing each other at a predetermined distance to repeatedly reflect the direct sounds and the indirect sounds in zigzag; and
a swing plate vertically dividing the opening of the double separator plate.
